(19) United States
(12) Patent Application Publication
(10) Pub. No.: US 2012/0137026 A1
(43) Pub. Date: May 31, 2012

(54) DEVICE AND METHOD FOR EXAMINING USB PORT OF TEST APPARATUS

(75) Inventors: HUIZHONG SHEN, Jiangsu Province (CN); CHING-FENG HSIEH, Taipei City (TW)

(73) Assignee: ASKEY COMPUTER CORP., Taipei (TW)

(21) Appl. No.: 12/980,494

(22) Filed: Dec. 29, 2010

(30) Foreign Application Priority Data
Nov. 30, 2010 (TW) 099141440

(51) Int. Cl. G06F 3/00

(52) U.S. Cl. 710/19

(57) ABSTRACT

A device and method for examining a USB port of a test apparatus are characterized in that before a functional test is performed, with the test apparatus, on an electronic product equipped with a USB interface, the device including a USB connector, a connecting unit, and an alerting unit is connected to the USB port of the test apparatus so as to examine the power supply status of the USB port of the test apparatus. Accordingly, the electronic product equipped with the USB interface is efficiently protected against damage which might otherwise arise from unstable power supply to or an error in the USB port of the test apparatus during the ensuing functional test.

### CROSS-REFERENCE TO RELATED APPLICATION

This non-provisional application claims priority under 35 U.S.C. §119(a) on Patent Application No(s). 099141440 filed in Taiwan, R.O.C. on Nov. 30, 2010, the entire contents of which are hereby incorporated by reference.

### FIELD OF THE TECHNOLOGY

The present invention relates to USB examination devices and methods, and more particularly, to a device and method for examining a USB port of a test apparatus.

### BACKGROUND

USB interfaces have a competitive advantage over other conventional interfaces, that is, plug and play, also known as hot plugging. There is a wide variety of electronic products that use a USB interface. For example, a USB interface is typical of a USB flash drive, USB wireless Internet card, USB video card, and USB controller. From a user's perspective, upon insertion of a USB connector of an electronic product into a USB port of an electronic apparatus (such as a desktop computer or a portable computer), the electronic product is supplied with power through the USB connector and the USB port of the electronic apparatus to thereby start automatically, create a protocol, or install a driver. After the aforesaid procedure is done, the user can start using and operating the electronic product through the electronic apparatus.

To perform quality control of an electronic product equipped with a USB interface, the manufacturer of the electronic product conducts a functional test or a compatibility verification process on the electronic product prior to delivery thereof. Normally, the functional test or the compatibility verification process comprises the steps of: putting in place a test apparatus on which test software is installed; inserting a USB connector of the electronic product into a USB port of a test apparatus; starting the electronic product; operating the electronic product according to test information provided by the test software or by means of the test apparatus; and determining whether the electronic product is functioning well.

However, since the USB port of the test apparatus supplies power to an electronic product equipped with a USB interface, instability or irregularity of the power supplied by the USB port results in insufficient power supply or suspension of power supply which causes the electronic product to malfunction or causes the test to fail. Severe instability or irregularity of the power supplied by the USB port results in unstable power supply or excessive power supply which can damage the electronic product. Therefore, to avoid unnecessary loss and wear, it is necessary to examine and evaluate the power supplied by the USB port of the test apparatus which is used for testing an electronic product equipped with a USB interface before testing the electronic product to determine whether the electronic product is functioning well.

### SUMMARY

In view of the shortcomings of conventional test methods, it is an objective of the present invention to provide an examination device and method effective in protecting an electronic product equipped with a USB interface from damage in the course of a test performed thereon.

In order to achieve the above and other objectives, the present invention provides a device for examining a USB port of a test apparatus. The device comprises a USB connector, a connecting unit, and an alerting unit. The USB connector is configured to be plugged into the USB port of the test apparatus which is used for testing an electronic product equipped with a USB interface. The connecting unit has an end electrically connected to the USB connector. The alerting unit is electrically connected to another end of the connecting unit for receiving power from the USB connector.

In order to achieve the above and other objectives, the present invention provides a method for examining a USB port of a test apparatus, particularly examining a power supply status of the USB port. The method comprises the steps of: plugging an examination device to the USB port of the test apparatus via a USB connector, wherein the examination device comprises the USB connector, an alerting unit, and a connecting unit electrically connecting the USB connector and the alerting unit; and determining a power supply status of the USB port of the test apparatus according to a status of the alerting unit of the examination device.

Technical features of an embodiment of the present invention include: the alerting unit is a light emitting element or a buzzer; the light emitting element is a light-emitting diode (LED); and the connecting unit is an extension cord.

In an embodiment of the present invention, the alerting unit is the light emitting element, wherein, if the status of the light emitting element is normal light emission, it will lead to the determination that the power supply status of the USB port of the test apparatus is normal.

In an embodiment of the present invention, when the alerting unit is a buzzer in a status of buzz, it is determined that the power supply status of the USB port of the test apparatus is normal.

Accordingly, before a functional test is performed, with a test apparatus, on an electronic product equipped with a USB interface, an electrical examination is performed on the USB port of the test apparatus, using the examination device of the present invention, such that the electronic product equipped with the USB interface is efficiently protected against damage during the ensuing functional test.

### BRIEF DESCRIPTION OF THE DRAWINGS

A detailed description of further features and advantages of the present invention is given below so that a person skilled in the art can understand and implement the technical contents of the present invention and readily comprehend the objectives, features, and advantages thereof by reviewing the disclosure of the present specification and the appended claims in conjunction with the accompanying drawings, in which:

FIG. 1 is a circuit diagram of a device for examining a USB port of a test apparatus according to an embodiment of the present invention;

FIG. 2 is a perspective view of the device for examining a USB port of a test apparatus according to an embodiment of the present invention;

FIG. 3 is a perspective view of the device for examining a USB port of a test apparatus according to another embodiment of the present invention; and

FIG. 4 is a flow chart of a method for examining a USB port of a test apparatus according to an embodiment of the present invention.

### DETAILED DESCRIPTION

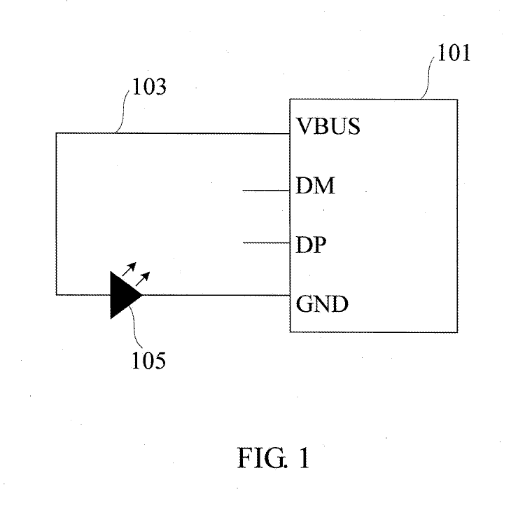

Referring to FIG. 1, there is shown a circuit diagram of a device for examining a USB port of a test apparatus according to an embodiment of the present invention. As shown in the drawing, the device comprises a USB connector 101, a connecting unit 103, and an alerting unit 105.

In general, all USB connectors have a power pin VBUS, a ground pin GND, and signal pins DM, DP. The present invention discloses making judgment according to the level of a voltage supposed to be supplied by a USB port. In case of abnormality of the voltage supplied by a USB port of a test apparatus, the difference in voltage between the power pin VBUS and the ground pin GND will deviate from the level of a voltage supposed to be supplied by the USB port. The USB port is supposed to supply a voltage of 5 volts approximately. The USB connector 101 of the present invention is configured to be connected to the USB port of the test apparatus, and allows power to be supplied to the alerting unit 105 through the connecting unit 103. By making reference to the voltage supposed to be supplied by the USB port, the alerting unit 105 is selectively to be driven at 5 volts, for example. Hence, if the USB port of the test apparatus is driven at an applied voltage larger than 5 volts, the alerting unit 105 will burn out. Conversely, if the USB port is driven at an applied voltage less than 5 volts, the alerting unit 105 will not function. If the USB port is driven at an applied voltage of 5 volts approximately, the alerting unit 105 will function well.

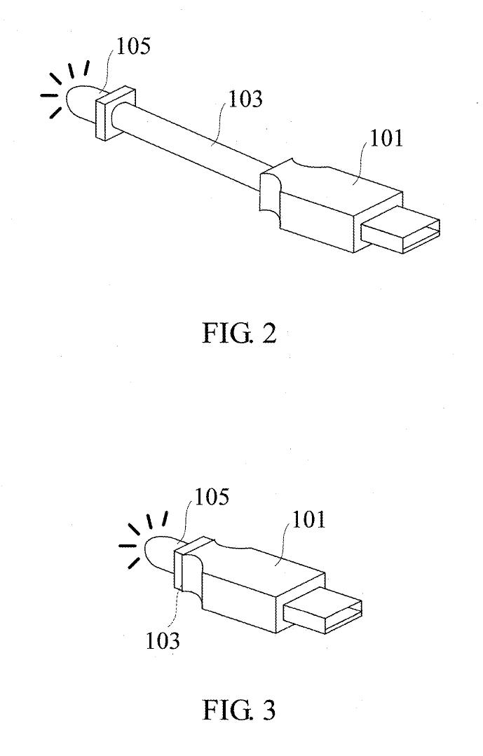

Referring to FIG. 2 and FIG. 3, there are shown perspective views of the device for examining a USB port of a test apparatus according to two embodiments of the present invention, respectively. In the embodiment illustrated with FIG. 2, the connecting unit 103 is an extension cord; in other words, the connecting unit 103 is a long wire. In the embodiment illustrated with FIG. 3, the connecting unit 103 comes in the form of an internal connection; in other words, the USB connector 101 is electrically connected to the alerting unit 105 by an internal connection, thereby dispensing with the long wire when viewed from outside. In the aforesaid two embodiments, the alerting unit 105 is a light-emitting diode (LED), and both the aforesaid two ways of connection require connecting the power pin VBUS and the ground pin GND of the USB connector 101 to the positive pin and the negative pin of the LED, respectively, through the connecting unit 103. Two wires are disposed inside the connecting unit 103 and configured to form an electrical circuit between the alerting unit 105 and the power pin of the USB connector 101.

Although, in the embodiments illustrated with FIGS. 1-3, the alerting unit 105 is the LED, the alerting unit 105 can be another light emitting element, such as a light bulb, in other embodiments. Hence, if the status of the LED is normal light emission, it will lead to the determination that the power supply status of the USB port of the test apparatus is normal. If the status of the LED is no light emission, it will lead to the determination that the power supply status of the USB port of the test apparatus is abnormal and therefore the likelihood that the LED might have burnt out or that power supply is not up to par and thus prevents the LED from functioning well.

In an embodiment where the alerting unit 105 is a buzzer in a status of buzz, it is determined that the power supply status of the USB port of the test apparatus is normal. Conversely, if the buzzer is in a status of no buzz, it is determined that the power supply status of the USB port of the test apparatus is abnormal and therefore the likelihood that the buzzer might have burnt out or that power supply is not up to par and thus prevents the buzzer from functioning well.

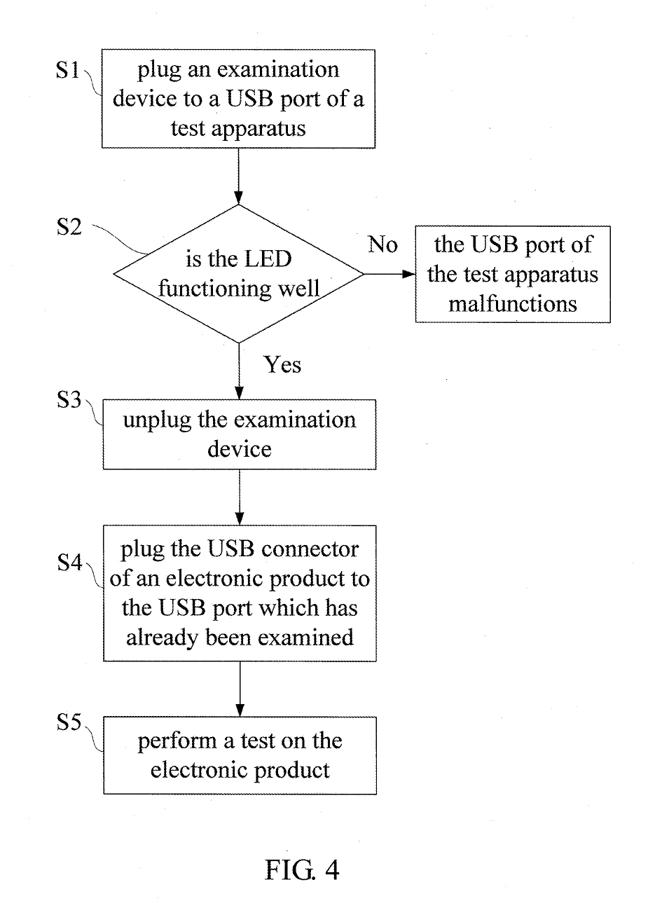

Referring to FIG. 4, there is shown a flow chart of a method for examining a USB port of a test apparatus according to an embodiment of the present invention. The examination method illustrated with FIG. 4 is performed on a USB port of a test apparatus with a view to examining the power supply status of the USB port, using the examination device shown FIG. 2. In the embodiment illustrated with FIG. 4, the alerting unit 105 is a light-emitting diode (LED).

Step S1: connecting a USB connector of an examination device to a USB port of a test apparatus, wherein the USB port functions as an interface for use in an ensuing test performed by the test apparatus on an electronic product equipped with a USB interface.

Step S2: determining whether a power supply status of the USB port of the test apparatus is normal according to whether light emission from a light-emitting diode (LED) is normal, wherein normal light emission from the LED leads to the determination that the power supply status of the USB port of the test apparatus is normal, and abnormal light emission (such as emitting no light or flashing) from the LED leads to the determination that the power supply status of the USB port of the test apparatus is abnormal.

In practice, the power supply status of the USB port of the test apparatus provides the basis of the determination as to whether it is appropriate for the test apparatus to continue performing the test on an electronic product equipped with a USB interface. In another embodiment of the present invention, the method for examining the USB port of the test apparatus further comprises the steps of:

Step S3: cutting off connection between the examination device and the USB port of the test apparatus upon determination that the power supply from the USB port of the test apparatus is normal.

Step S4: plugging the USB connector of an electronic product under test to the USB port which has already been examined.

Step S5: performing by the test apparatus various functional tests or compatibility verification processes on the electronic product.

To perform the method for examining a USB port of a test apparatus according to the present invention, it is not necessary to examine the power supply status of the USB port of the test apparatus before beginning each instance of testing an electronic product; in other words, after determining the power supply status of the USB port of the test apparatus in the step S1 and step S2, the test can be performed on an electronic product repeatedly. Hence, the power supply status of the USB port of the test apparatus is examined as needed prior to every instance of testing an electronic product.

The process flow of testing an electronic product according to the present invention is efficient, because it is free of cost-incurring interruptions which might otherwise follow the damage caused to an electronic product under test by a malfunctioning USB port of a test apparatus when no electrical test has been performed on the power supply status of the USB port of the test apparatus.

The foregoing embodiments are provided to illustrate and disclose the technical features of the present invention so as to enable persons skilled in the art to understand the disclosure of the present invention and implement the present invention accordingly, and are not intended to be restrictive of the scope of the present invention. Hence, all equivalent modifications and replacements made to the foregoing embodiments without departing from the spirit and principles in the disclosure of the present invention should fall within the scope of the present invention as set forth in the appended claims. Accordingly, the protection for the present invention should be defined by the appended claims.

1. A device for examining a USB port of a test apparatus, consisting of:
a USB connector configured to be plugged into the USB port of the test apparatus which is used for testing an electronic product equipped with a USB interface, wherein the USB connector has pins consisting of a power pin and a ground pin;
a connecting unit having an end electrically connected to the USB connector; and
an alerting unit electrically connected to another end of the connecting unit for receiving power from the USB connector.

2. The device of claim 1, wherein the alerting unit is one of a light emitting element and a buzzer.

3. The device of claim 2, wherein the light emitting element is a light-emitting diode (LED).

4. The device of claim 3, wherein the connecting unit is an extension cord.

5. The device of claim 3, wherein the connecting unit connects the power pin and the ground pin of the USB connector to a positive pin and a negative pin of the LED, respectively.

6. A method for examining a USB port of a test apparatus, particularly examining a power supply status of the USB port of the test apparatus, the method consisting of the steps of:
plugging an examination device to the USB port of the test apparatus via a USB connector, wherein the examination device consisting of the USB connector, an alerting unit, and a connecting unit electrically connecting the USB connector and the alerting unit to form an electrical circuit from the alerting unit and pins of the USB connector, the pins consisting of a power pin and a ground pin; and
determining a power supply status of the USB port of the test apparatus according to a status of the alerting unit of the examination device.

7. The method of claim 6, wherein, when the alerting unit is a light emitting element in a status of normal light emission, it is determined that the power supply status of the USB port of the test apparatus is normal.

8. The method of claim 6, wherein, when the alerting unit is a buzzer in a status of buzz, it is determined that the power supply status of the USB port of the test apparatus is normal.
